(19) United States
(12) Patent Application Publication
(10) Pub. No.: US 2008/0276419 A1
(43) Pub. Date: Nov. 13, 2008

(54) Load bar connection for overhead conveyor

(76) Inventor: Charles P. Tabler, Cincinnati, OH (US)

Correspondence Address: CHASE LAW FIRM L.C, 4400 COLLEGE BOULEVARD, SUITE 130, OVERLAND PARK, KS, 66211, US

(21) Appl. No.: 11/801,479

(22) Filed: May 10, 2007

(51) Int. Cl. E05D 11/00

(52) U.S. Cl. 16/223

(57) ABSTRACT

An overhead conveyor has a load bar provided with a two-way hinge that extends longitudinally of the load bar and has leaves pivotal about transverse axes. A lower leaf of the hinge is secured to the load bar and an upper leaf is secured to a depending carrier that extends clear of the load bar and downwardly for connection to a product being conveyed. The hinge opens in one direction of rotation when an upward incline is encountered and opens in the opposite direction when a downward incline is encountered, thereby allowing the carrier to remain in a vertical orientation to minimize product swing and potential damage.

This invention relates to overhead conveyors for transporting parts, products or materials in assembly or treatment operations.

### BACKGROUND OF THE INVENTION

Overhead conveyors are utilized in various production, transportation, assembly and treatment environments to transport parts or products through various operational stages. One type of overhead conveyor employs a rotating, generally horizontal drive tube or shaft that supports trolleys from which the load is suspended. Wheels on the trolleys ride on the upper surface of the rotating drive tube, and each is mounted for rotation about a driven wheel axis that is non-parallel and non-perpendicular to the drive tube axis, preferably at an acute angle to the drive axis. Overhead conveyors utilizing a drive where the load is suspended beneath the drive tube are disclosed, for example, in U.S. Pat. No. 5,785,168, issued Jul. 28, 1998, owned by the assignee herein.

When substantial loads are to transported, the trolleys ride on load rails beneath the drive tube and are provided with downwardly extending load support members or tabs which may be directly connected to the load. Heavy loads requiring more than one trolley for support are accommodated by a load bar generally parallel to the load rails and connected to the depending tabs of two or more spaced trolleys. A pivot on the load bar allows the suspended product to remain perpendicular to an underlying floor as the conveyor travels up and down inclines, but extreme product swing can cause damage as adjacent load bars come together and bump in a gravity buffer area, i.e., a non-driven stretch where the load rails are inclined downwardly. Other types of overhead conveyors may also induce extreme product swing during inclined travel, such as a chain conveyor in which the drive chain is pulled along a guide rail and has spaced load supports extending from the chain to which a load bar is connected. Similarly, extreme product swing can occur in power and free conveyors of the general type disclosed, for example, in U.S. Pat. No. 4,635,558, issued Jan. 13, 1986.

### SUMMARY OF THE INVENTION

In an embodiment of the present invention the aforementioned problem is addressed by providing an overhead conveyor in which the load bar is provided with a two-way hinge that extends longitudinally of the load bar and has leaves pivotal about transverse axes. A lower leaf of the hinge is secured to the load bar and an upper leaf is secured to a depending carrier that extends outwardly clear of the load bar and downwardly for connection to the product being conveyed. The hinge opens in one direction of rotation when an upward incline is encountered and opens in the opposite direction when an downward incline is encountered, thereby allowing the carrier to remain in a vertical orientation and, therefore, minimize product swing and potential damage.

In another aspect of the invention, a double-throw hinge having three leaves hinged end-to-end is provided and, when closed, presents a center leaf between a lower leaf secured to the load bar, and an upper leaf secured to the carrier by which the product is connected to the hinge and suspended therefrom.

Another aspect of the present invention is an improvement in overhead conveyors by providing a hinge on the load bar extending longitudinally thereof and having three leaves hinged end-to-end and, when closed, presenting a center leaf and upper and lower leaves pivotal about transverse axes. The lower leaf is secured to the load bar and a depending carrier hook is secured to the upper leaf and extends outwardly clear of the load bar, downwardly and inwardly beneath the load bar for connection to a product being conveyed, pivotal movement of the upper and center leaves in response to ascending and descending inclines of the load rail thereby maintaining the product at a substantially constant attitude.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 is a side perspective view of an overhead conveyor on an ascending incline in the conveyor line, looking upwardly and showing the load bar and the action of the two-way hinge.

FIG. 2 is a perspective view from the opposite side as compared to FIG. 1 showing the conveyor in horizontal travel and the carrier hook depending therefrom and supporting the load.

FIG. 3 is a diagrammatic, side elevational view of the prior art showing the trolley tabs, load bar, carrier hook and product.

FIG. 4 is a diagrammatic, side elevational view illustrating the two-way hinge of the present invention for attaching the carrier hook to the load bar.

FIG. 5 is a plan, detail view of the two-way hinge in a fully opened condition before attachment to a load bar.

FIG. 6 is an elevational view of the unfolded hinge shown in FIG. 5.

FIG. 7 is a detail view showing the hinge secured to the upper surface of a load bar (illustrated fragmentarily) and in an open condition caused by an ascending incline in the path of the conveyor.

FIG. 8 is a detail view similar to FIG. 7 but in an open condition caused by a descending incline in the path of the conveyor.

FIG. 9 is a detail view of the hinge fully closed illustrating the condition of the hinge when the conveyor is traveling horizontally.

### DETAILED DESCRIPTION

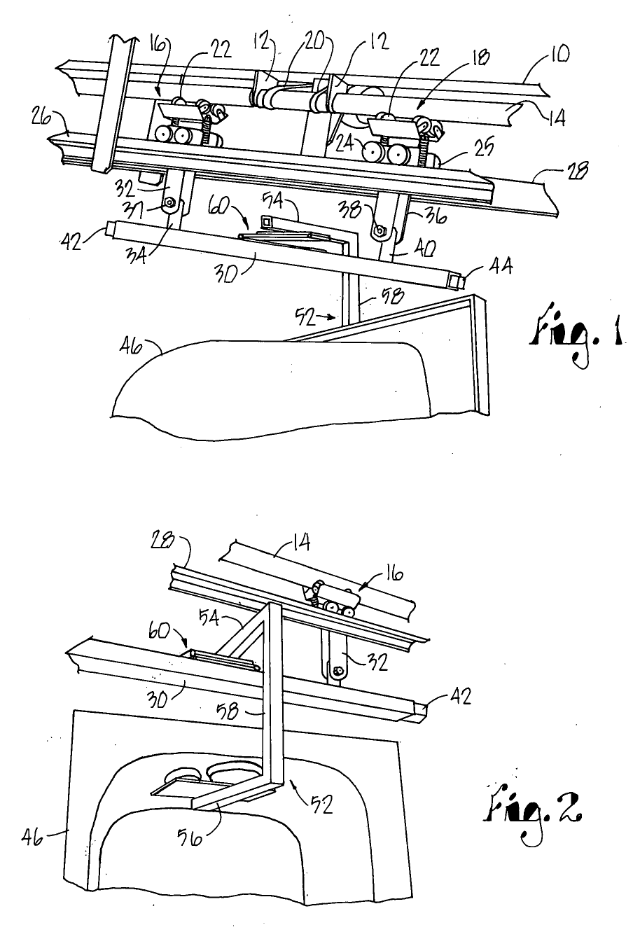

Referring to the drawings, FIG. 1 illustrates a stretch of an example of a type of an overhead conveyor provided with the improvement of the present invention. The conveyor is displaced approximately 10 degrees from a horizontal attitude and is thus conveying products (as described below) on an ascending incline in the conveyor line. It will be appreciated that longitudinally spaced bearing units 12 depending from a beam 10 support a drive tube 14 of the overhead conveyor beneath beam 10 shown in driving relationship to spaced, front and rear trolleys 16 and 18 respectively. The drive for the tube 14 is partially shown, i.e., two spaced drive belts 20 are between the supports 12. Each of the trolleys 16 and 18 is provided with a set of four drive wheels 22 which contact the surface of the drive tube 14, and four load wheels 24 which ride on the upper surface of a pair of parallel load rails 26 and 28. It will be appreciated that the load rails 26 and 28 are spaced apart and underlie respective pairs of load wheels 24 and 25 in the conventional manner, load rails 26 and 28 being spaced apart to provide a continuous opening therebetween to provide a connection to the load carried by the conveyor.

Parts, products or materials to be transported by the conveyor are borne by a load bar 30 extending fore and aft and spaced beneath the load rails 28, 26 as illustrated in FIG. 1. More particularly, the lead trolley 16 has a pair of transversely spaced load support tabs 32 projecting downwardly therefrom and connected by a cross bolt 37 to an upstanding stud 34 secured to the load bar 30 by a thrust bearing (not shown) in a conventional manner. Likewise, a pair of load support tabs 36 depend from the rear trolley 18 and are joined by a cross bolt 38 to an upstanding stud 40 secured to the load bar 30. Accordingly, the load bar 30 is spaced below the load rails 26, 28 and is maintained in parallelism therewith during horizontal travel and ascending and descending inclines. As is also conventional, the load bar 30 is provided with a forwardly projecting rubber bumper 42 at its forward end, and a rearwardly projecting rubber bumper 44 at its rear end.

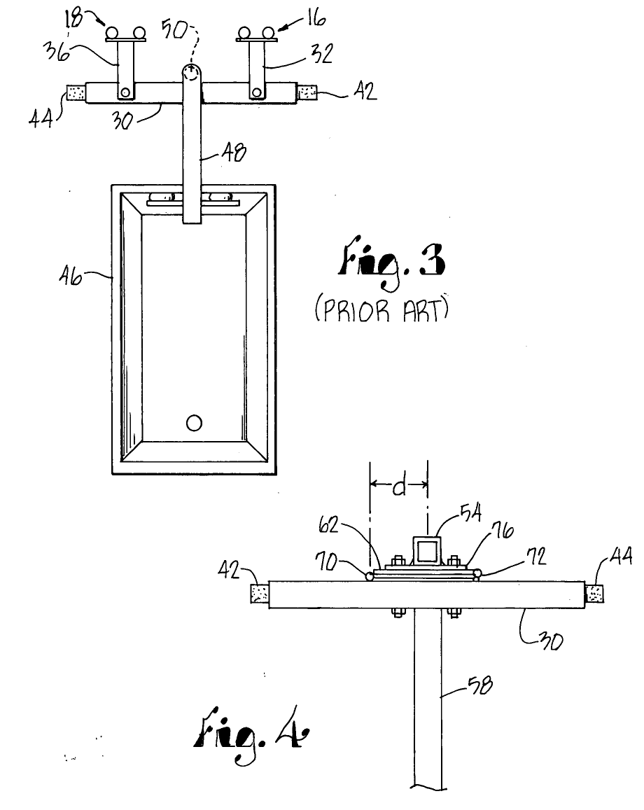

FIGS. 3 and 4 diagrammatically illustrate the manner in which a product is connected to the load bar 30 in the prior art and in the present invention. For purposes of illustration, the product 46 shown in FIGS. 1-3 is a bath tub suspended from load bar 30. In the prior art (FIG. 3), the upper end of a hanger 48 is joined to the load bar 30 by a pivotal connection 50 which provides an axis at right angles to load bar 30 and the direction of travel of the conveyor. The hanger 48 would typically comprise a C-shaped carrier hook in order to position the product 46 directly below the load bar 30. Pivot 50 provides an axis at right angles to the direction of movement of the conveyor so that the product 46 ideally remains perpendicular to an underlying floor (not shown) while the conveyor travels up and down inclined paths as well as horizontal to the floor. However, a problem is encountered in that extreme product swing about pivot 50 can cause damage as adjacent load bars come together and bump in a gravity buffer area, i.e., a non-driven stretch where the load rails are inclined downwardly.

Referring to FIGS. 1 and 2, in the present invention the hanger or carrier hook 52 is of generally C-shaped configuration and includes an upper, generally horizontal arm 54 connected to a lower, generally horizontal arm 56 by a normally vertically extending leg 58 to present a C-shaped configuration to position the product 46 directly below the load bar 30. The upper arm 54 is connected to the load bar 30 via a two-way hinge 60 shown in detail in FIGS. 5-9. In FIGS. 5 and 6 the hinge 60 is shown in a fully opened, unfolded condition presenting outer leaves 62 and 66 and a center leaf 64, each of approximately equal length. FIG. 9 shows the hinge fully closed and secured to the upper surface 30a of the load bar 30 (shown fragmentarily) by two flat-head bolts 68 received in spaced holes 69 in leaf 66. In the condition shown in FIG. 9 the hinge is fully collapsed, thus center leaf 64 is folded about hinge pin 70 and is in overlying contact with lower leaf 66. The fully folded hinge is completed by upper leaf 62 folded about hinge pin 72 into overlying relationship with center leaf 64. Bolts 74 secure leaf 62 to an upper plate 76 to which upper arm 54 is welded, thus rigidly affixing the carrier hook 52 to the upper plate 62 of the hinge 60. The fully folded condition is also shown in FIG. 4. Distance “d” is varied in sizing the hinge depending on the weight of the product 46. The heavier the product 46, the greater the distance “d” from arm 54 to each of the hinge pins 70 and 72 as more dampening is needed.

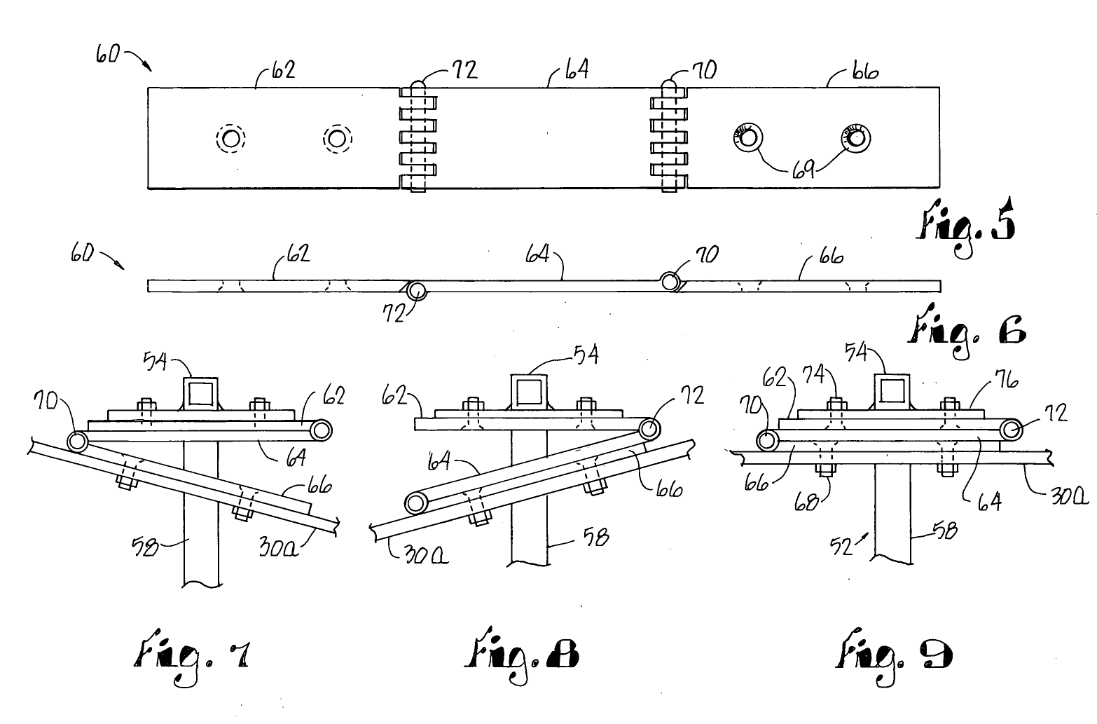

From the foregoing it may be appreciated that the outer leaves of the two-way hinge 60 (i.e., leaves 62 and 66) are fixed to the carrier hook and to the load bar respectively so that the hinge will open in one direction as in FIG. 7 about hinge pin 70 or in the other direction about hinge pin 72 (illustrated in FIG. 8) depending upon whether the conveyor is on an ascending incline or a descending incline. It will further be appreciated in FIG. 7 that the upper and center leaves 62 and 64 remain in engagement and swing as a unit about hinge pin 70 on an ascending incline; similarly, on a descending incline (FIG. 8) the lower and center leaves 66 and 64 remain in engagement while the upper leaf 62 swings about hinge pin 72 to maintain the connecting leg 58 of the hanger 52 in a substantially vertical disposition in order to prevent any significant product swing. In this manner, extreme product swing that could be induced in a gravity buffer area is prevented by the action of the two-way hinge.

It should be understood that while certain forms of this invention have been illustrated and described, it is not limited thereto except insofar as such limitations are included in the following claims.

Having thus described the invention, what is claimed as new and desired to be secured by Letters Patent is:

1. In an overhead conveyor having an elongated load bar extending in a direction of travel of the conveyor, apparatus for connecting the load bar to a product carried by the conveyor comprising:
a two-way hinge on the load bar extending longitudinally thereof and presenting upper and lower leaves pivotal about transverse axes,
said lower leaf being secured to said load bar, and
a depending carrier secured to said upper leaf and extending outwardly clear of said load bar and downwardly therefrom for connection to a product, whereby action of the two-way hinge in response to ascending and descending inclines in the direction of travel maintains the product at a substantially constant attitude.

2. In an overhead conveyor having a load rail along which a load is transported and load supports movable along said rail, depending therefrom and connected to a load bar, apparatus for connecting the load bar to a product carried by the conveyor comprising:
a hinge on the load bar extending longitudinally thereof and having three leaves hinged end-to-end and, when closed, presenting a center leaf and upper and lower leaves,
said lower leaf being secured to said load bar, and
a depending carrier secured to said upper leaf and extending outwardly clear of said load bar and downwardly therefrom for connection to a product, whereby pivotal movement of said upper and center leaves away from said lower leaf or movement of said upper leaf away from said center and lower leaves in response to ascending and descending inclines in the load rail maintains the product at a substantially constant attitude.

3. In an overhead conveyor having an elongated load bar extending in a direction of travel of the conveyor, apparatus for connecting the load bar to a product carried by the conveyor comprising:
a hinge on the load bar extending longitudinally thereof and having three leaves hinged end-to-end and, when closed, presenting a center leaf and upper and lower leaves pivotal about transverse axes,
said lower leaf being secured to said load bar, and
a depending carrier hook secured to said upper leaf and extending outwardly clear of said load bar, downwardly therefrom and inwardly beneath the load bar for connection to a product, whereby pivotal movement of said upper and center leaves in response to ascending and descending inclines in the direction of travel maintains the product at a substantially constant attitude.
